(19) United States
(12) Patent Application Publication
(10) Pub. No.: US 2007/0137334 A1
(43) Pub. Date: Jun. 21, 2007

(54) Construction of transmission gear sleeve with retarded descent function

(76) Inventor: Ching-Che Wu, Hsin Chu City (TW)

Correspondence Address: LEONG C LEI, PMB # 1008, 1867 YGNACIO VALLEY ROAD, WALNUT CREEK, CA, 94598, US

(21) Appl. No.: 11/290,547

(22) Filed: Dec. 1, 2005

(51) Int. Cl. F16H 27/02

(52) U.S. Cl. 74/89.39

(57) ABSTRACT

The present invention provide with a new construction of transmission gear sleeve with retarding descent function, with one end of transmission gear sleeve bolt to the ball sleeve transmission member, and its other end in series connecting with two plates type pressure bearing, washer, bearing, sliding seat, two plates type pressure bearing, facing conical spring plates, seat and retaining ring in assembly, its features are: The extruding outward force of two sets of facing conical spring in transmission gear sleeve apply on two plates type pressure bearing, cause the tighten of transmission gear sleeve with sliding seat revolution by increasing of ball friction coefficient, then slow down the instant descending speed of sliding seat within safety range in case of system power cut.

### BACKGROUND OF THE INVETION

(a) Technical Field of the Invention

The invention relates to the new construction of transmission gear sleeve with retarded descent function during power cut of the system, a couple of facing conical spring plates on transmission gear sleeve extruding outward in order to press the two plates type pressure bearing, and then increasing the friction coefficient of the inner ball, therefore forcing the transmission gear sleeve to the sliding seat revolution tightly, and retarding the instant descending speed of the sliding seat favors the owner in case of a power cut

(b) Description of the Prior Art

The usually design of a vertical worm driving platform integrate the worm drive with the transmission bushing of sliding seat equipment, the upper and down displacement of platform is driven by the motor on side of the sliding seat, however, owing to the design of transmission bushing with sliding seat adapt bearing set, once system power cut, platform down, the sliding block slips downward with acceleration due to free motion of the driving motor, the accident would cause products damaged and persons harmed, so owner would like to embrace the new one free from this kind of troubles.

### SUMMARY OF THE INVENTION

According to the first aspect of the present invention, there is provided a new transmission gear sleeve with retarding descent function, specially one end of the transmission gear sleeve connecting in series with two plates type pressure bearing, washer, bearing, sliding seat, two plates pressure bearing, a couple of facing conical spring plate, seat and retaining ring, specially for safety descent of sliding seat during system power cut.

According to the second aspect of the present invention, there is provided a new construction of transmission gear sleeve with retarding descent function, two sets of two facing conical spring plates in series design cause extruding outward of spring plate applying a force on two plates type pressure bearing, and then increase the friction coefficient of inner ball, therefore forcing the transmission gear sleeve to the sliding seat revolution tightly.

According to the third aspect of the present invention, there is provided a new construction of transmission gear sleeve with retarding descent function, one end of the transmission gear sleeve is designed to bolt the ball sleeve transmission member instead of traditional one with plastic material, for special increase of the accuracy of sliding seat up and down movement and its longer life span.

### BRIEF DESCRIPTION OF THE DRAWINGS

FIG. 1 is a perspective view showing the assembly of the present invention.

FIG. 2 is an exploded view showing the various components of the present invention

FIG. 3 is a sectional view of the transmission gear sleeve according to the present invention.

FIGS. 4A and 4B are perspective views of the conical spring force applied to two types pressure bearing according to the present invention.

FIGS. 5A and 5B are perspective views of the sliding seat retarding descent comparison according to the present invention.

### DETAILED DESCRIPTION OF THE PREFERRED EMBODIMENTS

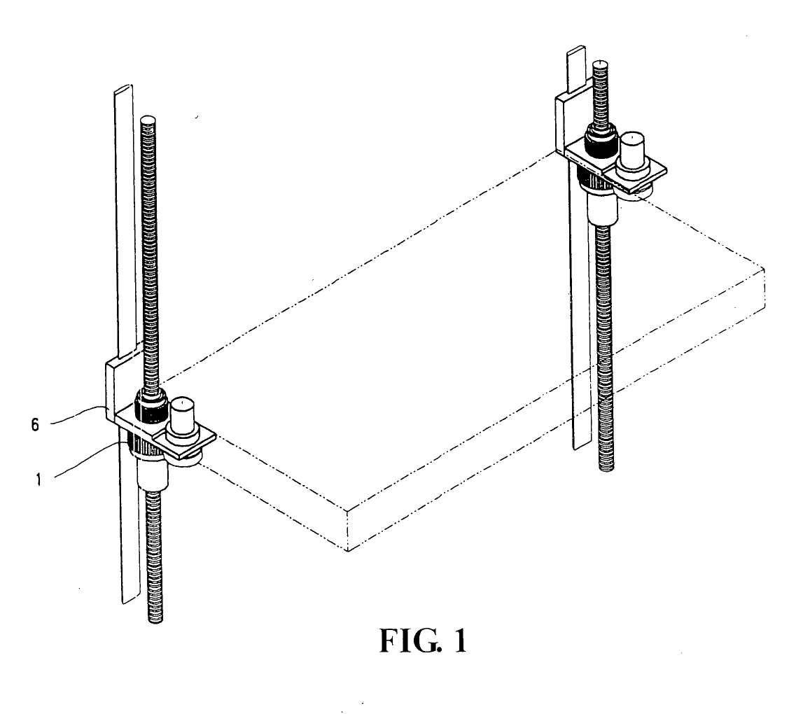

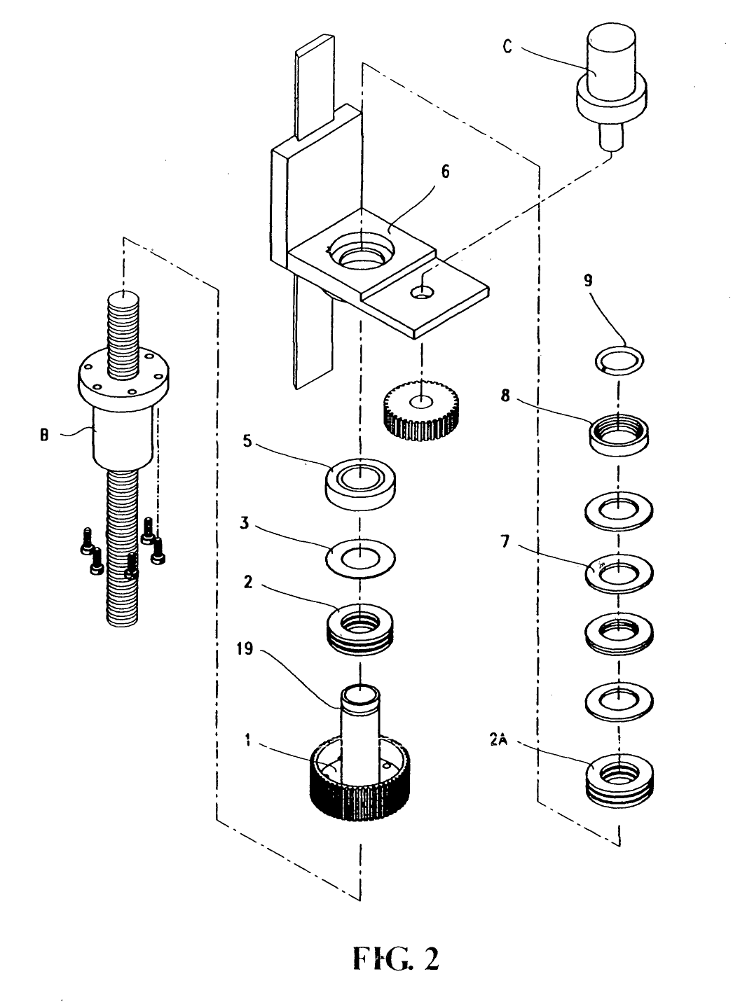

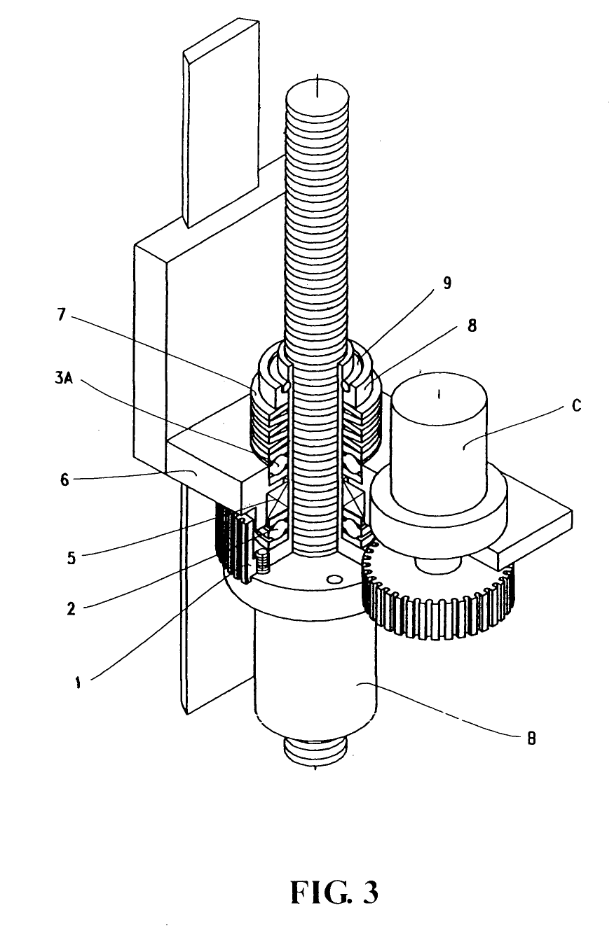

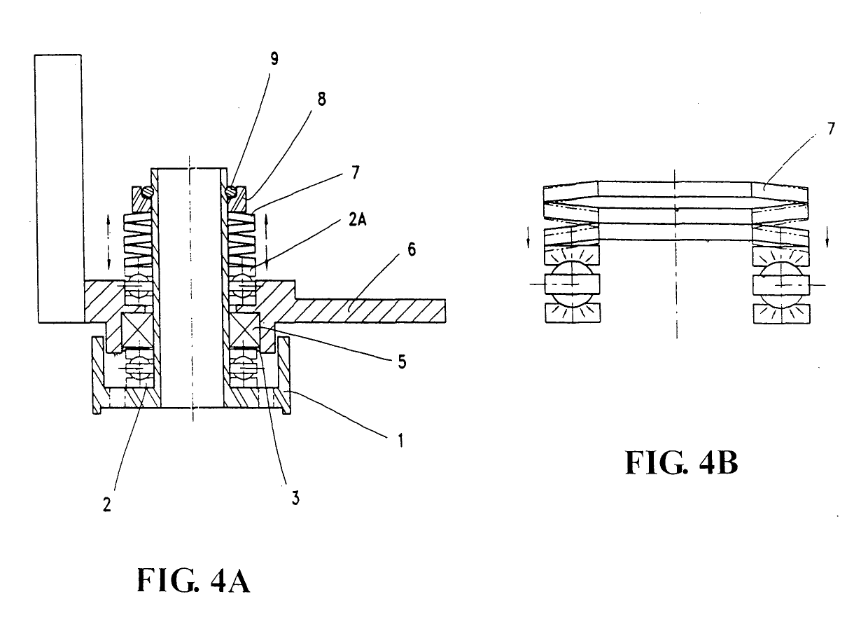

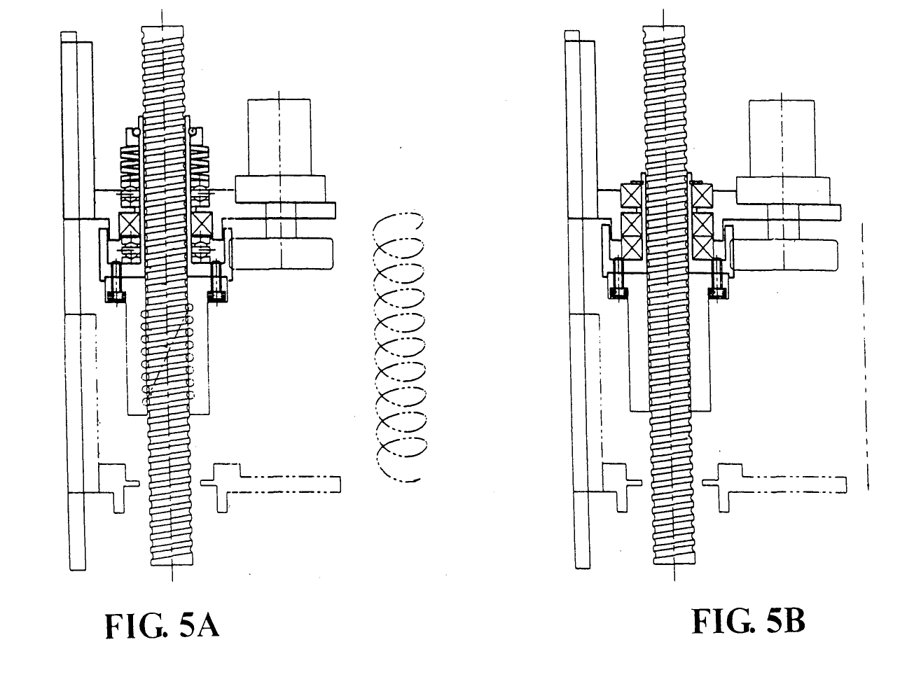

Please refer from FIG. 1 to FIG. 5, the present invention is provided a new construction of transmission gear sleeve with retarding descent function, it consists of a transmission gear sleeve 1 with retarding descent function, pressure bearing 2, 2A, washer 3, bearing 5, sliding seat 6, conical spring plate 7, seat 8, and retainer ring 9: its transmission gear sleeve 1 is a extruding tube with a position holding retaining groove 19 at one end is for fitting of two plates type pressure bearing 2, washer 3, bearing 5, sliding 6, two plates type pressure bearing 2A, conical spring plate 7 facing each other, and a retaining groove seat 8 in series in position, for purpose of tighten fitting of C shape clip and retaining ring 9 in position of holding retaining groove 19, therefore the design of seat 8 inner diameter is exactly the same of retaining ring 9 outside diameter, then the reverse force of spring plate would hold retaining ring 9 free from falling, this the outstanding design of the present invention.

The operating mechanism of the present invention is bolding the ball sleeve transmission member B to the one end of transmission gear sleeve 1, the motor C on the side of the sliding seat drive the ball sleeve transmission member, so the up and down movement of sliding seat, at the same time, due to the spring force of the two sets of two facing conical spring plates in the transmission gear sleeve , extruding outward spring to apply a force on the two plates type pressure bearing 2, 2A, increasing the tightness of transmission gear sleeve and sliding seat revolution by the increase of the ball friction coefficient, therefore slow down the sliding seat instant descending speed to a safety range in case the system power cut.

I claim:

1. A method as claimed in claim 1, a new construction of transmission gear sleeve with retarding descend function, it consists of transmission gear sleeve, two sets of pressure bearing, washer, bearing, sliding seat, conical spring plates, seat and retaining ring: its transmission gear sleeve is a extruding tube with a position holding retaining groove at one end is for fitting of two plates type pressure bearing, washer, bearing sliding seat, two plates type pressure bearing, conical spring plates facing each other, and a retaining groove seat in series in position, for tighten fitting of C shape clip and retaining ring in position of holding retaining groove, and the inner diameter of seat is designed as the same of the outside diameter of retaining ring, therefore the reverse spring force would hold the retaining ring free from falling; due to the spring force of two sets facing conical spring plates in transmission gear sleeve, extruding outward of spring caused a force applying on two plates type pressure bearing, tighten transmission gear sleeve with sliding seat revolution by the increase of ball friction coefficient, therefore a outstanding performance of slow down the sliding seat instant descending speed within a safety range in case of system power cut would be seen.
